(19) United States
(12) Patent Application Publication
(10) Pub. No.: US 2011/0255842 A1
(43) Pub. Date: Oct. 20, 2011

(54) PROVIDING A UNIFORM USER EXPERIENCE

(75) Inventors: James Hindle, London (CA); Paul Rechsteiner, Toronto (CA); Ian Bell, Waterloo (CA); Michael Malcolm, Aspen, CO (US); Tom Barnett, Sunnyvale, CA (US); Stephen Watson, Toronto (CA)

(73) Assignee: Kaleidescape, Inc., Sunnyvale, CA (US)

(21) Appl. No.: 13/088,331

(22) Filed: Apr. 15, 2011

Related U.S. Application Data
(60) Provisional application No. 61/324,679, filed on Apr. 15, 2010.

(51) Int. Cl. H04N 9/80

(52) U.S. Cl. 386/262; 386/E09.011

(57) ABSTRACT

A method of providing a uniform user experience is described. The method entails receiving general preference information, and mapping the general preference information to format-specific preference information. This format-specific preference information can then be applied when accessing content.

### CROSS REFERENCE TO RELATED APPLICATIONS

This application claims priority to and the benefit under 35 U.S.C. §119(e) of copending U.S. Provisional Patent Application No. 61/324,679, entitled “PROVIDING A UNIFORM USER EXPERIENCE” by Hindle et al., filed on Apr. 15, 2010, which is hereby incorporated by reference as if fully set forth herein.

### BACKGROUND

1. Field of the Invention

Embodiments of the present invention relate to providing a uniform user experience across multiple media formats.

2. Related Art

As digital media formats continue to proliferate, an increasing problem for the user is the disparity in the user experience as they move between media formats. For example, the functionality of the controls used to manipulate playback of a DVD in a DVD player may differ significantly from the functionality of the controls used to manipulate playback of a Blu-ray disc in a blue laser player; indeed, the controls may vary in functionality between two different Blu-ray discs. Similarly, different media formats (or, again, different examples of the same media format) will present audio and language options in different ways, have different versions of parental controls (if any), and may react differently to available options within a home theater environment.

### SUMMARY

A method of providing a uniform user experience is described. The method entails receiving general preference information, and mapping the general preference information to format-specific preference information. This format-specific preference information can then be applied when accessing content.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary computer system, upon which embodiments may be implemented.

FIG. 2 depicts an exemplary media server environment, in accordance with one embodiment.

FIG. 3 depicts an exemplary media server environment, in accordance with one embodiment.

FIG. 4 depicts an exemplary Blu-ray player, in accordance with one embodiment.

FIG. 5 depicts an exemplary Blu-ray player, in accordance with one embodiment.

FIG. 6 depicts a method of configuring audio preferences for a media player, in accordance with one embodiment.

FIG. 7 depicts a method of configuring language preferences for a media player, in accordance with one embodiment.

FIG. 8 depicts a method of providing a uniform user experience, in accordance with one embodiment.

### DETAILED DESCRIPTION

Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

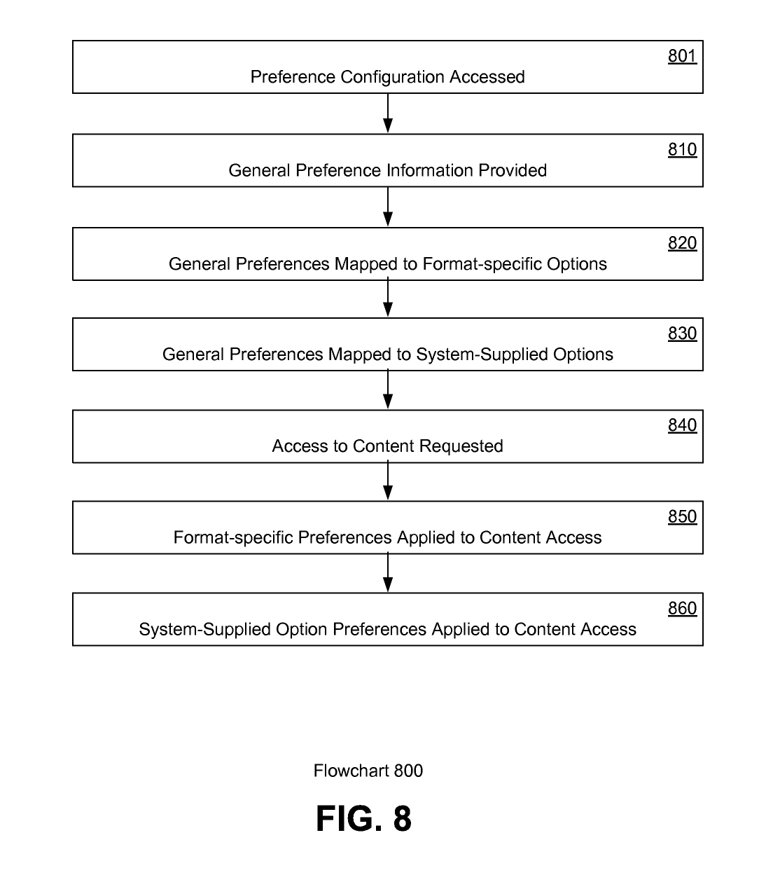

Portions of the detailed description that follows are presented and discussed in terms of a method. Although steps and sequencing thereof are disclosed in figures herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc,. that perform particular tasks or implement particular abstract data types. Typically the functionality of the program modules may be combined or distributed as desired in various embodiments.

### Basic Computing System

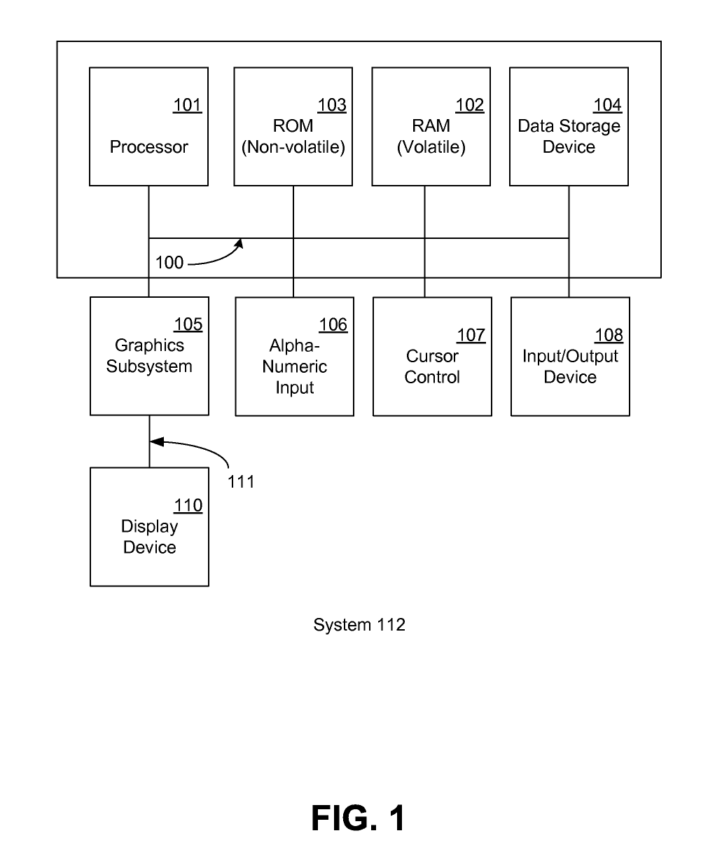

Referring now to FIG. 1, a block diagram of an exemplary computer system 112 is shown. It is appreciated that computer system 112 described herein illustrates an exemplary configuration of an operational platform upon which embodiments may be implemented to advantage. Nevertheless, other computer systems with differing configurations can also be used in place of computer system 112 within the scope of the present invention. For example, computer system 112 may include additional, fewer, or different elements other than those described in conjunction with FIG. 1. Moreover, embodiments may be practiced on any system which can be configured to enable it, not just computer systems like computer system 112. It is understood that embodiments can be practiced on many different types of computer system 112. System 112 can be implemented as, for example, a desktop computer system or server computer system having a powerful general-purpose CPU coupled to a dedicated graphics rendering GPU. In such an embodiment, components can be included that add peripheral buses, specialized audio/video components, IO devices, and the like. Similarly, system 112 can be implemented as a handheld device (e.g., cellphone, etc.) or a set-top video game console device such as, for example, the Xbox®, available from Microsoft Corporation of Redmond, Washington, or the PlayStation3®, available from Sony Computer Entertainment Corporation of Tokyo, Japan. System 112 can also be implemented as a “system on a chip”, where the electronics (e.g., the components 101, 103, 105, 106, and the like) of a computing device are wholly contained within a single integrated circuit die. Examples include a hand-held instrument with a display, a car navigation system, a portable entertainment system, and the like.

Computer system 112 comprises an address/data bus 100 for communicating information, a central processor 101 coupled with bus 100 for processing information and instructions; a volatile memory unit 102 (e.g., random access memory [RAM], static RAM, dynamic RAM, etc.) coupled with bus 100 for storing information and instructions for central processor 101; and a non-volatile memory unit 103 (e.g., read only memory [ROM], programmable ROM, flash memory, etc.) coupled with bus 100 for storing static information and instructions for processor 101. Moreover, computer system 112 also comprises a data storage device 104 (e.g., hard disk drive) for storing information and instructions.

Computer system 112 also comprises an optional graphics subsystem 105, an optional alphanumeric input device 106, an optional cursor control or directing device 107, and signal communication interface (input/output device) 108. Optional alphanumeric input device 106 can communicate information and command selections to central processor 101. Optional cursor control or directing device 107 is coupled to bus 100 for communicating user input information and command selections to central processor 101. Signal communication interface (input/output device) 108, which is also coupled to bus 100, can be a serial port. Communication interface 108 may also include wireless communication mechanisms. Using communication interface 108, computer system 112 can be communicatively coupled to other computer systems over a communication network such as the Internet or an intranet (e.g., a local area network), or can receive data (e.g., a digital television signal). Computer system 112 may also comprise graphics subsystem 105 for presenting information to the computer user, e.g., by displaying information on an attached display device 110, connected by a video cable 111. In some embodiments, graphics subsystem 105 is incorporated into central processor 101. In other embodiments, graphics subsystem 105 is a separate, discrete component. In other embodiments, graphics subsystem 105 is incorporated into another component. In other embodiments, graphics subsystem 105 is included in system 112 in other ways.

### Exemplary Media Server Environment

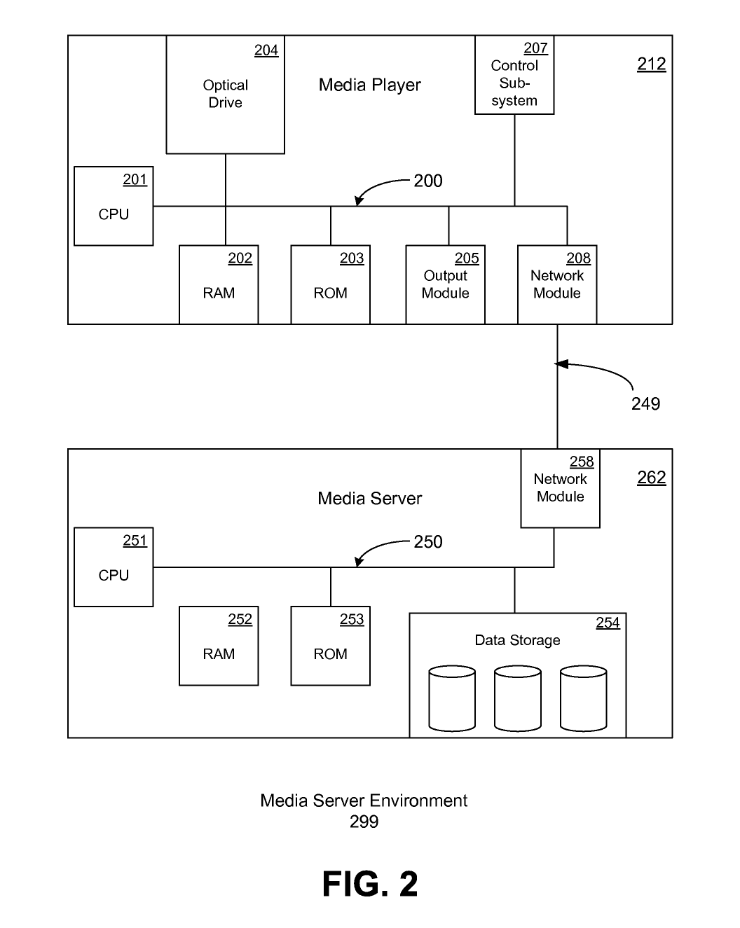

With reference now to FIG. 2, an exemplary media server environment 299 is depicted, in accordance with one embodiment. While media server environment 299 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 299 is shown as comprising two devices: media player 212, and media server 262. Media player 212 includes: bus 200 for communicating information; a central processor 201 coupled with bus 200 for processing information and instructions; a volatile memory unit 202 (e.g., random access memory [RAM], static RAM, dynamic RAM, etc.) coupled with bus 200 for storing information and instructions for central processor 201; and a non-volatile memory unit 203 (e.g., read only memory [ROM], programmable ROM, flash memory, etc.) coupled with bus 200 for storing static information and instructions for processor 201. Moreover, media player 212 incorporates optical drive 204, coupled with bus 200, for accessing data stored on optical media, e.g., CDs or DVDs. Media player 212 also incorporates output module 205, coupled with bus 200, for outputting audio and/or video data. Media player 212 is also shown as incorporating networking module 208, coupled with bus 200, for transmitting and receiving information, e.g., over a network connection. In the depicted embodiment, media player 212 also incorporates control subsystem 207. Control subsystem 207 is coupled with bus 200, and receives control signals for controlling the functionality of media player 212, as well as for manipulating digital content being played on media player 212.

As shown in the depicted embodiment, media player 212 is communicatively coupled to media server 262 via network connection 249. In different embodiments, network connection 249 may be implemented in different ways. For example, network connection 249 may be implemented as a TCP/IP connection, transmitted via Ethernet or a wireless connection.

Media server 262 includes: bus 250 for indicating information; a CPU 251 coupled with bus 250 for processing information and instructions; a volatile memory unit 252 (e.g., random access memory [RAM], static RAM, dynamic RAM, etc.) coupled with bus 250 for storing information and instructions for central processor 251; and a non-volatile memory unit 253 (e.g., read only memory [ROM], programmable ROM, flash memory, etc.) coupled with bus 250 for storing static information and instructions for processor 251. Media server 262 also includes data storage device 254, depicted here as a RAID array (redundant array of inexpensive disks), coupled with bus 250 for storing digital media content. Media server 262 further includes networking module 258, coupled with bus 250, for transmitting and receiving information, e.g., over a network connection.

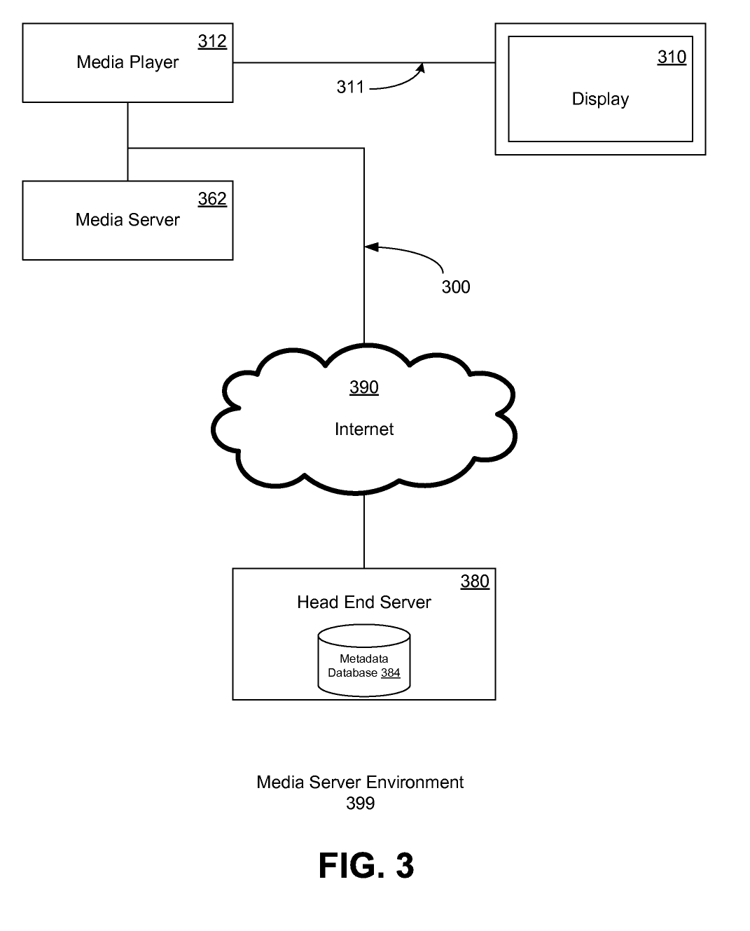

With reference now to FIG. 3, an exemplary media server environment 399 is depicted, in accordance with one embodiment. While media server environment 399 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

In the depicted embodiment, media server 362 is used to store digital media content. Media server 362 is communicatively coupled with media player 312 via network connection 300. Media player 312, in the depicted embodiment, retrieves digital media content from server 362 and plays it back, e.g., by outputting digital video content over video cable 311 to display 310. Media server 362 is also communicatively coupled to a head end database 380, via network connection 300, and the Internet 390. Head end database 380 includes metadata database 384. Media server 362, in this embodiment, is configured to retrieve metadata corresponding to digital content from metadata database 384.

In different embodiments, digital media content may be available from sources other than media server 362. In one such embodiment, for example, media server 362 and/or media player 312 may be able to access or download digital media content from a remote source, e.g., head end database 380, or a remote digital media storage device (not pictured). Similarly, in some embodiments, digital media content may be available in accordance with a digital rights management (DRM) scheme, such as a “rental” scenario where digital media content is available to be viewed for a fixed length of time, or for a specified number of playbacks.

### Uniform User Experience

The following embodiments described the various approaches to creating a more uniform user experience. Several of the embodiments are directed to a media server environment, where a media server provides access to content to various media players distributed throughout a network. Several of the described embodiments address the need to simplify or streamline the user experience, as it relates to expressing preferences for playback of media content, and enforcing those preferences. Several of the described embodiments address the disparity in user experience that results from different media formats, or variations within a particular media format.

While the embodiments detailed here in discuss specific technologies, such as Blu-ray discs and blue laser players suitable for accessing content stored on Blu-ray discs, it is understood that embodiments are well suited to applications involving alternative technologies, including but not limited to downloadable or streaming content retrieved from a remote server, or television content received via antenna, cable, or satellite.

### Multi-Format Media Server Environment

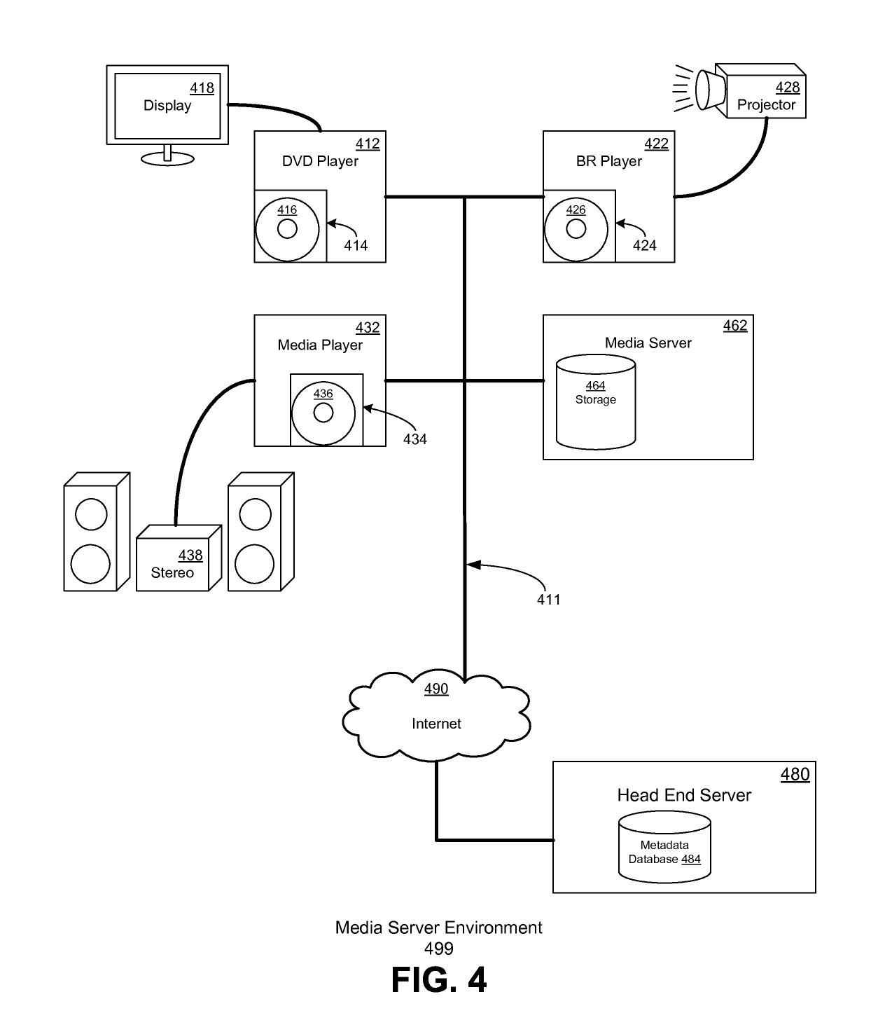

With reference now to FIG. 4, an exemplary media server environment 499 is depicted, in accordance with one embodiment. While media server environment 499 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 499 incorporates a variety of media playback devices, and can accommodate playback of multiple media formats.

In the depicted embodiment, media server environment 499 includes: DVD player 412, which contains DVD optical drive 414, currently containing DVD 416, and is communicatively coupled to display 418; blue laser player 422, which contains blue laser optical drive 424, currently containing Blu-ray disc 426, and is communicatively coupled to a projector element 428; media player 432, which contains optical drive 434, currently containing CD 436, and is communicatively coupled to stereo element 438; and media server 462, which includes storage element 464. Media server 462 is coupled with the media players in media server environment 499 via network 411; network 411 also allows access to head end server 480, and metadata database 484, via Internet 490. In some embodiments, network 411 may also be used to access other locations via Internet 490, e.g., locations accessible via BD-Live content on a Blu-ray disc, or locations from which downloadable or streaming content may be obtained.

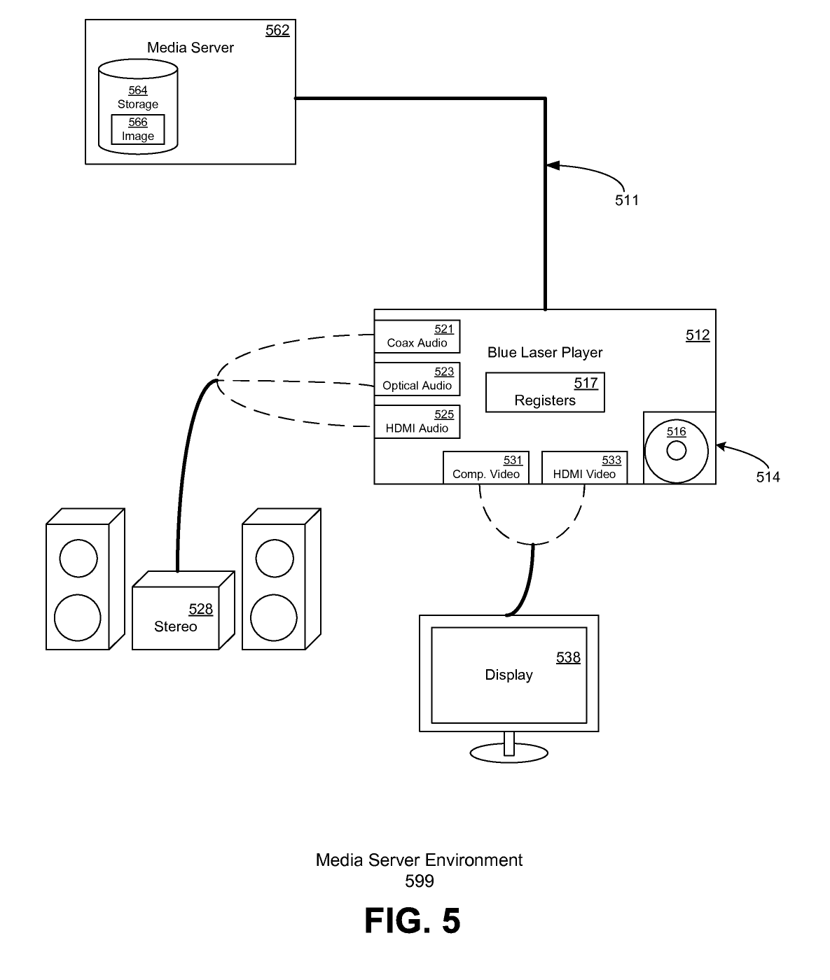

With reference now to FIG. 5, an exemplary media server environment 599 is depicted, in accordance with one embodiment. While media server environment 599 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 599 is depicted as containing media server 562, blue laser player 512, and several media presentation devices, stereo 528, and display 538. Media server 562 includes storage element 564, containing image 566. Media server 562 communicates with blue laser player 512 via network 511. The laser player 512 is depicted as including blue laser optical drive 514, containing Blu-ray disc 516. The laser player 512 is also shown as including a number of registers 517; in some embodiments, settings affecting playback of content via blue laser player 512 are stored in registers 517. Blue laser player 512 also includes a number of media output elements: coax audio port 521, optical audio port 523, HDMI audio port 525, composite video output 531, and HDMI video output 533. Blue laser player 512 is coupled with stereo 528 by one or more of the available audio ports; blue laser player 512 is coupled with display 538 by one or more of the available video outputs.

### Uniform Audio Preferences

One of the problems arising from supporting multiple media formats in a media player or media server environment relates to audio configuration and playback options. Different media formats allow for different audio options, and impose different limitations. For example, Blu-ray content allows for lossless or high definition audio content to be included on the Blu-ray disc, for playback on audio hardware which supports the appropriate audio format; however, the licensing terms for Blu-ray content restrict which types of audio ports may be utilized to output such audio content. As such, it is possible to configure the audio options of a blue laser player in a manner which may prevent audio being output over the correct ports to communicate with the available audio hardware.

Additionally, media formats specify certain rules for audio configuration and output. For example, the specification for Blu-ray content requires that an audio track selected for playback satisfy two conditions: that the media player be capable of playing back the selected audio track, and that the language of the audio track match a preferred language. Both of these conditions can be checked via registers settings within the blue laser player. However, this test does not check for the best available audio track; as such, the first audio track which meets these conditions on a particular Blu-ray disc may be selected for playback, even if a higher quality audio track is available that would also meet these conditions.

In some embodiments, a user is invited to choose from a selection of audio preferences at a media server or media player level. These audio preferences can then be mapped onto be differing sets of possible audio preferences allowed by different media formats, e.g., DVD, Blu-ray, or CD, accessible via the media server or player. When playback of content is requested, the user's audio preferences, as mapped onto the appropriate format, are used to select from the available audio options corresponding to the selected content. Moreover, in some embodiments, the user may supply additional granularity to these preferences. In one such embodiment, the user may specify that one set of audio preferences be used for playback of a specified type or genre of content, and other preferences be used for other content, e.g., stereo audio should be used for playback of concert and music performances, while surround sound should be used for motion pictures.

Additionally, in some embodiments, user preferences may be used in conjunction with metadata associated with media content. For example, it is not uncommon for digital content to be distributed with multiple audio tracks in the same language; a DVD or Blu-ray disc of a feature presentation may include multiple “English” audio tracks, for example—one or more may contain the audio for the feature presentation, while others may include commentary tracks with the cast or director of the feature. In one such embodiment, externally-provided metadata, such as metadata retrieved from Head End Server 380 and Metadata Database 384, may allow a user and/or a media server or player, such as media player 312, to differentiate between these audio tracks.

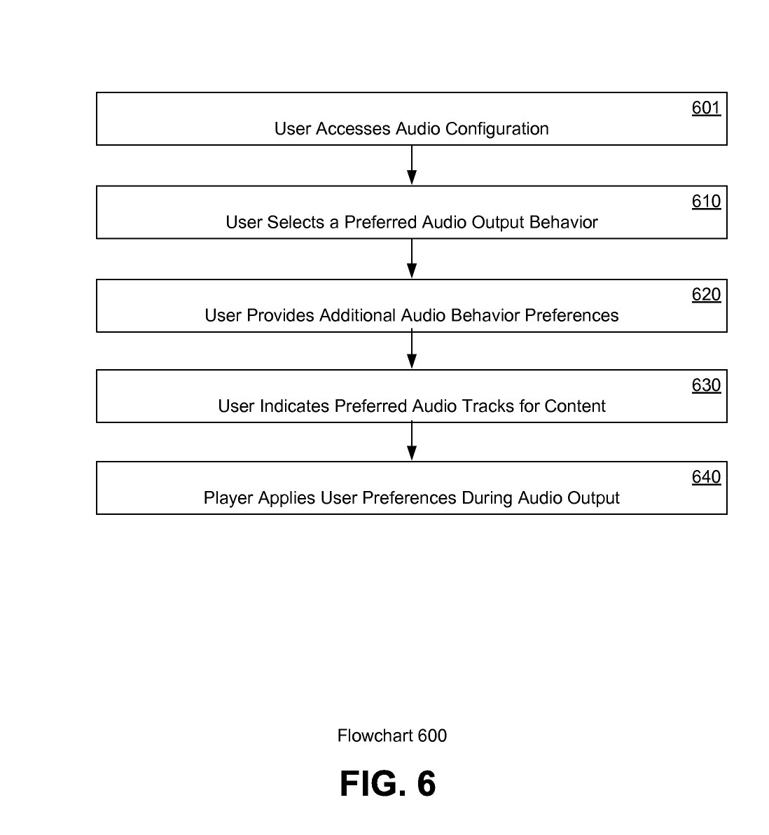

With reference now to FIG. 6, a flowchart 600 of a method of configuring audio preferences for a media player is depicted, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

With reference now to step 601, an audio configuration utility is accessed. In different embodiments, a user may access the audio configuration for a media player in different ways. For example, audio configuration may be performed using an on-screen display, controls directly on the media player, a network-based Web browser interface, a computer program, or some other approach. In different embodiments, the audio configuration utility may configure the media player, or may configure a media server environment; in several such embodiments, different media players within the same media server environment may have different audio configuration settings. Additionally, in some embodiments, the audio configuration utility may allow for multiple profiles, e.g., different users may be able to configure different audio preferences for the same media player.

For example, a user may access an audio configuration utility for blue laser player 512, and select options which appear on display 538, using a control device for blue laser player 512.

With reference now to step 610, a preferred audio output behavior is selected. In some embodiments, the user is allowed to select from certain specified output behaviors; in one such embodiment, the user indicates which should be the default audio output behavior. For example, the user may be able to select between high definition audio output available only over an HDMI audio connection between the media player and a suitable audio receiving device, or a lower quality audio output available over multiple audio connections. The available options will vary across different embodiments, as the options available on different media players will vary.

Continuing the preceding example, the user is asked to select between outputting audio solely over HDMI, via HDMI audio port 525, and outputting audio over all available audio ports. If HDMI-only audio is selected, lossless audio output may be available for certain content, e.g., up to 7.1-channel audio formats, but no audio will be output over coax audio port 521 or optical audio port 523. Alternatively, allowing output over the analog audio ports, e.g., audio port 521 or optical audio port 523, will also output audio over HDMI audio port 525, but this output is limited to (up to) 5.1-channel audio formats.

With reference now to step 620, additional audio behavior preferences may be provided. In some embodiments, the user is allowed to select additional audio behaviors, in order to provide additional granularity in audio preference selection. For example, the user may select whether auto detection of display or receiver capabilities via HDMI is enabled, select digital audio output preferences, select audio processing preferences, select stereo mode preferences, or select dynamic range preferences; in other embodiments, other audio preferences may be selectable. In some embodiments, this step may be omitted; alternatively, some or all of these audio preferences may be grouped together under an “advanced audio preferences” menu item, in order to reduce inadvertent setting manipulation or user confusion.

Continuing the preceding example, the user is allowed to determine whether to allow auto detection of the capabilities of stereo 528 via an HDMI connection to HDMI audio port 525.

With reference now to step 630, preferred audio tracks for content playback are indicated. In some embodiments, the user indicates preferences before audio tracks available on digital content. For example, the user may indicate a preference for a high definition audio track, a surround sound audio track, or a stereo audio track, depending upon available audio hardware and personal preferences. In some embodiments, the options presented in this step may depend upon one or more of the preferences indicated during steps 610 and 620.

Continuing in the preceding example, the user is allowed to select a preferred audio track for content to be played on blue laser player 512, choosing from high definition audio, surround sound audio, or stereo tracks.

With reference now to step 640, the media player utilizes the user preferences during audio output. In some embodiments, the user preferences are applied when playback of content is initiated. For example, if the user has indicated a preference for high resolution audio output over an HDMI audio port, the player will select a high resolution audio track from the available options corresponding to the content to be played, and output that audio track via the HDMI audio port. In some embodiments, if the preferred audio track is unavailable from the selected content, the media player may select another audio track: for example, if the content is a DVD which does not contain a high definition audio track, the media player may select a surround sound audio track.

In different embodiments, different approaches are utilized to allow the player to select between available audio tracks. In some embodiments, content includes information associated with the available audio tracks, such that the media player can identify which audio track corresponds to user preferences; for example, Blu-ray discs include information associated with available audio tracks, such that a high definition audio track can be distinguished from a surround sound audio track or a stereo audio track. In other embodiments, metadata may be utilized to allow the media player to select between available audio tracks; for example, a media player may obtain metadata corresponding to the selected content from a media server, or from a remote head end server, to allow it to distinguish between the available audio tracks.

Continuing the preceding example, blue laser player 512 initiates playback of the content associated with image 566, stored on media server 562. Blue laser player 512 applies the user preferences stored in registers 517, and selects an available surround sound audio track for output to stereo 528 over optical audio port 523.

### Uniform Language Preferences

Another problem resulting from multiple media formats is how to handle language preferences across different formats. Most forms of media have their own approach to handling language selection, both for audio tracks and for subtitles. For example, DVDs use a two character indicator to designate a particular language; Blu-ray discs use a three character designation.

In some embodiments, one objective is to provide a uniform approach to allow users to specify languages in which to experience media. In several such embodiments, users can provide a language preference for audio tracks, as well as for subtitles; this preference will be respected across playback of multiple media formats, including DVDs and Blu-ray discs. Additionally, in some embodiments, users can provide additional granularity in their language preference selections. For example, a user can indicate a preferred language for audio tracks, and then indicate that either the audio track for the original presentation language should be used, in combination with subtitles in the preferred language, or that the preferred language audio track should be used regardless of the original presentation language, and no subtitles should be used. Similarly, other options may include indicating that specified language and subtitle combinations should be used for certain genres, e.g., presentation of an opera, but not for others.

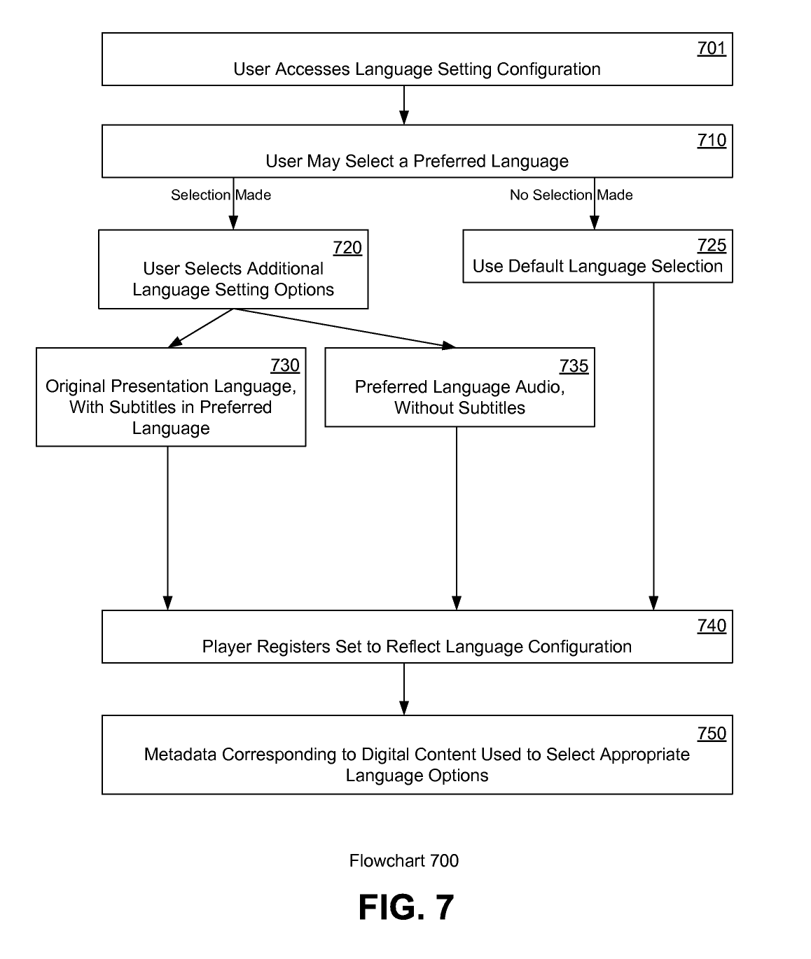

With reference now to FIG. 7, a flowchart 700 of a method of configuring language preferences for a media player is depicted, in accordance with one embodiment. Although specific steps are disclosed in flowchart 700, such steps are exemplary. That is, embodiments of the present invention are well suited to performing various other (additional) steps or variations of the steps recited in flowchart 700. It is appreciated that the steps in flowchart 700 may be performed in an order different than presented, and that not all of the steps in flowchart 700 may be performed.

With reference now to step 701, a language preference configuration utility is accessed. In some embodiments, a user may access language preference settings in order to specify preferred languages for playback of media content. In different embodiments, a user may access the language preference configuration tool for a media player in different ways. For example, language preference settings may be manipulated using an on-screen display, controls directly on the media player, a network-based Web browser interface, a computer program, or some other approach. In different embodiments, the language preference configuration utility may configure the media player, or may configure a media server environment; in several such embodiments, different media players within the same media server environment may have different language preference settings. Additionally, in some embodiments, the language preference configuration utility may allow for multiple profiles, e.g., different users may be able to configure different language preferences for the same media player.

For example, with reference to FIG. 5, a user accesses a language preference configuration utility associated with blue laser player 512. The user may interact with the utility via display 538 and a control device configured to control blue laser player 512.

With reference now to step 710, a preferred language may be selected. In some embodiments, the user may be presented with a choice of selections for preferred language settings. In several such embodiments, a user may either make a choice of a particular preferred language, or may refrain from making a choice.

Continuing the preceding example, the language preference configuration utility presents a list of selectable preferred languages to the user for selection. The user may use the control device configured to control blue laser player 512 to indicate a preferred language, or may refrain from making a selection.

With reference now to step 720, if a selection of a preferred language is made, additional language setting configuration options may be presented. In some embodiments, after a preferred language has been selected, the user may be invited to provide additional details, as regards presentation of media content. In other embodiments, the step may be omitted.

Continuing the preceding example, if the user chooses a preferred language from the list of selectable preferred languages, additional configuration options are presented for the user's consideration.

With reference now to step 725, if a preferred language is not selected, the media player uses a default language selection. In different embodiments, different approaches are utilized. In one embodiment, for example, if no preferred language is selected, the media player will use the current language selection as a preferred value. In a different embodiment, the media player may examine the available data, such as region for DVD and/or Blu-ray disc content, and choose a language appropriate to the available regions. In another embodiment, the media player may receive information from a media server or another media player within the media server environment, and utilize language preferences similar to other media players within the media server environment.

For example, with reference to FIG. 4, if no language preference selection is made for DVD player 412, media server 462 may copy the language preferences for blue laser player 422 for use in DVD player 412.

With reference now to step 730, one language setting configuration option specifies that audio tracks corresponding to an original presentation language associated with content should preferentially be used, and subtitles in the selected preferred language presented.

With reference now to step 735, one language setting configuration option specifies that audio tracks corresponding to the selected preferred language should preferentially be used during playback of content, and that subtitles should not be used.

As discussed above, it is understood that additional configuration combinations and permutations are available in different embodiments. Moreover, also as discussed above, additional granularity in the choice of audio tracks and/or subtitles is available in different embodiments. For example, a user may specify more than one preferred language, and indicate a preferred order for selection of audio tracks during presentation of content.

With reference now to step 740, language configuration settings are recorded. In some embodiments, language preferences may be stored in registers within the media player; for example, blue laser media players incorporate registers specifically to record preferred language settings. In other embodiments, language preferences may be stored in a media server with the media server environment; in one such embodiment, this approach is utilized in order to facilitate more complex language preference settings, such as specifying certain language and/or subtitle options for a particular genre of content. In other embodiments, other approaches are utilized to store language preferences.

For example, when applying language configuration settings to a blue laser player, the following approaches may be utilized. In the case where no preferred language is specified, all three BD language registers (audio, subtitle and menu) may be set to 0×FFFFFF (not specified). This implies that the language code on the streams will not come into play when selecting streams; playback of the content from the disc will use the default menu language for the media player, and no subtitles will be presented by default.

If a preferred language, language L, is selected, and language settings indicate that the user prefers the audio track corresponding to the original presentation language, the subtitle and menu language registers for the media player are set to the code corresponding to L. For the audio language, if metadata is available which indicates the country of production for the content, the ‘official languages’ for the country of production are examined. If there is one official language, and a corresponding audio track, the audio language register may be set to the corresponding code. If there are multiple official languages, these languages are compared to the languages available on the disc, and the audio register may be set to the code corresponding to the language of the first stream that matches one of the official languages. If there isn't one, e.g., because the country of production is unknown, or no official language can be determined, or no audio track exists for the official language, the audio language register may be set to “not specified (e.g., 0×FFFFFF), in order to allow the disc to pick the default language.

After audio stream selection, if the selected language for the audio track is not L, and L is available in the subtitle streams, subtitles may be enabled.

If a preferred language, language L, is selected, and the user indicates a preference for audio tracks corresponding to language L, all three language registers may be set to the code corresponding to L. However, if audio is not available in L, but subtitles are, the audio track is set to the original presentation language, with subtitles in L enabled.

With reference now to step 750, metadata corresponding to content is utilized to select appropriate language options. In different embodiments, and for different media, different approaches may be utilized. For example, as previously discussed Blu-ray discs may incorporate indicators which designate which audio tracks are in which languages. In other embodiments, a media server may examine metadata that indicates which audio track corresponds to a preferred language, or which subtitle option should be selected. In some embodiments, where all content contains the necessary information to select the appropriate audio and/or subtitle option according to the specified language preferences, it may not be necessary to receive additional metadata.

### Playback Manipulation

Another issue resulting from multiple media formats is handling playback manipulation commands. Different media formats may implement playback manipulation in different ways. For example, a DVD format did not specify a required behavior for fast-forward or rewind commands; DVD player manufacturers were allowed to select their own behaviors for these commands, e.g., by specifying how fast playback of digital content should advance when a fast-forward command was received. Other media formats, such as BD-J formatted titles on Blu-ray discs, typically do not allow the manufacturer this same degree of freedom: in the case of BD-J titles, the controlling Java program on a particular disc specifies how to react to playback manipulation commands such as fast-forward and rewind.

In some embodiments, it is useful to provide a more uniform user experience by streamlining operations of playback manipulation commands. Specifically, in some embodiments, a media player should respond to playback manipulation commands in the same way, regardless of which media content is being presented. In one such embodiment, for example, fast-forward, rewind, chapter skip, pause, and play commands are handled uniformly for DVD playback, CD playback, and Blu-ray disc playback. It may be necessary for minor variations to occur in handling specific commands, depending upon the requirements of a given media format.

### Blu-Ray Disc Stop Command

As noted above, in some embodiments, different media formats require implementing playback manipulation commands in different ways. One such scenario arises out of the use of the “stop” command during playback of Blu-ray content.

Under certain conditions, instructing a media player to stop playback of Blu-ray digital content should not actually stop execution of the current Java xlet running on the media player. Such a condition may arise, for example, during playback of multi-disc digital content, e.g., episodic content which spans multiple disks. Instead, the user should be instructed to remove one disc, and insert another, upon which playback will continue.

In some embodiments, in a media server environment, a media player will react to a “stop” command by returning control of the media player to a top-level content selection menu. In several such embodiments, in order to implement this variant “stop” functionality in a media server environment, the media player is made aware of the current state of the Blu-ray playback engine, in order to allow a determination as to whether to stop playback and return to a top-level content selection menu, or to allow execution of the current Java xlet to continue.

In one such embodiment, during playback of Blu-ray digital content and upon receipt of a “stop” command, the media player will query the current navigation session in order to determine whether there is an active unbound xlet, e.g., by instructing the current navigation session to terminate, and receiving a Boolean indicator in reply, indicating the absence or presence of an active unbound xlet. If there is no active unbound xlet, he media player can react to the “stop” command in the expected fashion, by returning control to the top-level content selection menu. If there is an active unbound xlet, however, the media player waits for further input from the user: if the user should hit stop again, or if the user fails to insert the appropriate disc, the media player can react by returning control to the top-level content selection menu.

### Parental Controls

Another issue that arises out of multiple media formats is the question of content access controls, such as parental controls. Some formats incorporate parental controls; other formats do not. For those formats which do allow parental controls, not every specific piece of content will utilize them. In the case of Blu-ray discs, for example, parental controls are incorporated into the specification: a blue laser player incorporates a register to specify an age ranging from zero to 255; Blu-ray discs may incorporate age limitations for content; if the age specified by the blue laser player is less than the age limitation included on the content, the content should not be accessible. However, such age limitations are inconsistently applied by Blu-ray disc publishers.

In some embodiments, it is advantageous for media players within a media server environment to utilize an alternative form of parental control. A blue laser player within the media server environment can be set to an age of 255, in order to prevent difficulties with any Blu-ray disc content age limitation. Metadata associated with content can then be used to implement an alternative parental control scheme, such as a scheme where parents are allowed to exclude content by rating, genre, as the title, or any other available piece of metadata; alternatively, the metadata associated with the content may include suggested age limitations, which can be incorporated into a parental control scheme.

### Method of Providing a Uniform User Experience

With reference now to FIG. 8, a flowchart 800 of a method of providing a uniform user experience is depicted, in accordance with one embodiment. Although specific steps are disclosed in flowchart 800, such steps are exemplary. That is, embodiments of the present invention are well suited to performing various other (additional) steps or variations of the steps recited in flowchart 800. It is appreciated that the steps in flowchart 800 may be performed in an order different than presented, and that not all of the steps in flowchart 800 may be performed.

With reference now to step 801, a preference configuration is accessed. In different embodiments, different approaches may be utilized to allow a user to access preferences for a media player or media server environment.

With reference now to step 810, general preference information is received. In some embodiments, a user is allowed to specify certain general preferences, as regards a user experience while using a media player or media server environment. For example, the user may be up to provide preference information as regards the languages to be used while presenting content, or which audio options should be utilized.

With reference now to step 820, general preference information is mapped to format-specific options. In some embodiments, the general preference information provided by a user can be used across different media formats, even if those media formats offered differing options.

With reference now to step 830, general preference information is mapped to system-supplied options. In some embodiments, a media player or media server environment may offer additional options, beyond those supplied by the media formats accessible via the system; the general preference information supplied by the user may influence the application or settings associated with such system-supplied options. For example, a media server environment may offer additional parental control options, beyond those inherent in the DVD or Blu-ray formats; if the user's general preferences indicate that parental controls should be enabled, the media server environment may utilize the additional parental control options.

With reference now to step 840, access to content is requested.

With reference now to step 850, format-specific preferences are applied to content access. In some embodiments, after the general preference information has been mapped to the options available within a given format, those format-specific preferences are applied when content is accessed. For example, if a user has indicated a general preference for a particular language for audio tracks, when a Blu-ray disc is accessed, the system may utilize an audio selection method, similar to that described above with reference to FIG. 6.

With reference now to step 860, system-supplied option preferences are applied to content access. As discussed above, in some embodiments, the user's general preferences may be utilized to select certain system-offered options. In several such embodiments, format-specific preferences and system-supplied option preferences are both applied to content access. For example, as discussed above, parental controls may be present both for certain media formats, such as Blu-ray discs, and also as part of the media server environment used to access such formats. Both sets of parental controls are applied during content access; in one such embodiment, the age specified for a media player is set to 255, and that age is used in determining how to apply parental controls inherent in Blu-ray content. Once the Blu-ray parental controls have been applied, the system may also apply another set of parental controls, e.g., one based on metadata associated with content.

Embodiments of the present invention are thus described. While the present invention has been described in particular embodiments, it should be appreciated that the present invention should not be construed as limited by such embodiments, but rather construed according to the following claims.

What is claimed is:

1. A method, comprising:
receiving general preference information;
mapping said general preference information to format-specific option information; and
applying said format-specific preference information when accessing content.

2. The method of claim 1, wherein said general preference information comprises user preference information.

3. The method of claim 1, wherein said general preference information comprises preferred language setting information.

4. The method of claim 1, wherein said general preference information comprises preferred audio setting information.

5. The method of claim 1, further comprising:
mapping said general preference information to system-supplied option information.

6. The method of claim 5, further comprising:
applying said system-supplied option information when accessing said content.

7. The method of claim 1, further comprising:
receiving a request to access said content.

8. A method of configuring language preferences, comprising:
selecting a preferred language;
recording language configuration settings, with reference to said preferred language; and
utilizing metadata to select appropriate language options, with reference to said preferred language.

9. The method of claim 8, further comprising:
accessing a language setting configuration utility.

10. The method of claim 8, wherein said selecting further comprises:
selecting an additional language setting option.

11. The method of claim 10, wherein said additional language setting option specifies that an original audio presentation language should be presented, and subtitles corresponding to said preferred language should be presented.

12. The method of claim 10, wherein said additional language setting option specifies that an audio track corresponding to said preferred language should be presented.

13. The method of claim 8, wherein said selecting further comprises:
specifying a plurality of preferred languages; and
indicating a preferred order for said plurality of preferred languages.

14. The method of claim 8, wherein said recording comprises:
storing said language configuration settings in registers within a media player.

15. A method of audio configuration, comprising:
selecting a preferred audio output behavior;
indicating a preferred audio track; and
utilizing said preferred audio output behavior and said preferred audio track during playback of content.

16. The method of claim 15, wherein said selecting said preferred audio output behavior comprises:
selecting said preferred audio output behavior from a plurality of output options.

17. The method of claim 15, wherein said indicating said preferred audio track further comprises:
selecting a plurality of preferred audio tracks, wherein each of said plurality is associated with a specified category of content.

18. The method of claim 15, wherein said selecting said preferred audio output behavior further comprises:
providing additional audio behavior preferences.

19. The method of claim 18, wherein said utilizing further comprises:
utilizing said additional audio behavior preferences during playback of said content.

20. The method of claim 15, further comprising:
accessing an audio configuration utility.
